(19) United States
(12) Patent Application Publication
(10) Pub. No.: US 2015/0138353 A1
(43) Pub. Date: May 21, 2015

(54) SMART DOORBELL WITH ENERGY SAVING METHOD

(71) Applicant: Amaryllo International, Inc., Zhubei City (TW)

(72) Inventors: Chao-Tung YANG, Zhubei City (TW); Shu-Hua LIU, Zhubei City (TW)

(73) Assignee: Amaryllo International, Inc., Zhubei City (TW)

(21) Appl. No.: 14/160,181

(22) Filed: Jan. 21, 2014

(30) Foreign Application Priority Data
Nov. 20, 2013 (TW) 102142303

(51) Int. Cl. H04N 7/18

(52) U.S. Cl. CPC H04N 7/186; H04N 7/188
USPC 348/143

(57) ABSTRACT

Disclosed is an energy-saving method for operating a smart doorbell including an activating element which is in a sleeping mode when the activating element is not activated, the activating element includes an electrical doorbell, a photographing module, a communicating module, a first processor, and a second processor, the method comprises: a step of activating the first processor while a movement of an object is sensed by a first sensor; a step of activating the photographing module and the second processor while a second sensor senses that the object is approaching toward the electrical doorbell, analyzing an image information of the object captured by the photographing module; and a step of activating the communicating module while the image information is analyzed that has a human image approaching toward the electrical doorbell, so as to achieve a goal of real time response to a bell call by consuming less energy.

### FIELD OF THE INVENTION

The present invention relates to a doorbell operating method, and more particularly to an energy saving method for operating a smart doorbell.

### BACKGROUND OF THE INVENTION

With a development of computer technology and a pursuing of informationalized digital home, a household installed with intelligent appliances, called as an intelligent household such as a networking household or a digital household, has become one of the popular technologies in these days. The technology of intelligent household is a key technology for achieving the digitalization of the home appliances, which provides the possibility of building a connection from one home appliance to another and transmitting information at anytime and in anywhere.

There is a new introduced smart doorbell that provides a visible screen for people inside the house to check the identity of a visitor so as to decide whether or not to open the door. However, since this kind of smart doorbell requires a high performance processor for processing multiple intelligent functions and for performing a remote control in a networking environment, it causes a problem that the smart doorbell needs to be stood by in an operating mode for responding to any doorbell call in real time, so it will consume much power and causes a frequent battery exchange. On the other hand, if the smart doorbell is configured to be in a sleeping mode in most of the time, it will have disadvantage of time consuming in operation due to the switching from the sleeping mode to the operating mode.

### SUMMARY OF THE INVENTION

In view of the above, it is an important issue to solve the problems by providing a smart doorbell that can have a real time response but consuming less power over the conventional smart doorbell.

Accordingly, an aspect of the present invention is to provide an energy saving method for operating a smart doorbell that overcomes the above drawbacks.

An aspect of the present invention is to provide an energy-saving method for a operating a smart doorbell, by which the smart doorbell is operated in an energy-saving manner, wherein said smart doorbell comprises a sensing element and an activating element, the sensing element comprises a first sensor and a second sensor, the activating element comprises an electrical doorbell, a photographing module, a communicating module, a first processor, and a second processor. The activating element is in a sleeping mode before being activated. The energy-saving method of the smart doorbell comprises: a step of activating the first processor, in which the first processor is activated from the sleeping mode when the first sensor senses a movement of an object; a step of activating the photographing process, in which the photographing module and the second processor are activated from sleeping mode when the second sensor sensed that the object is approaching toward the doorbell, so that the photographing module captures an image of the object and analyzes the captured image information of the object; and a step of activating the communicating process, in which the communicating module is activated from the sleeping mode when the analyzed image information is analyzed as that a human being is approaching toward the doorbell.

According to an aspect of the present invention, the first processor is a low energy consuming processor, and the second processor is a main processor.

According to an aspect of the present invention, the first sensor is an infrared light sensor.

According to an aspect of the present invention, the second sensor is a thermal energy sensor.

According to an aspect of the present invention, it further comprises a step of deactivating for a non-contact intention after the step of activating the photographing process, in which the second processor is switched to the sleeping mode when the analyzed image of the human being is recognized as not to contact the electrical doorbell.

According to an aspect of the present invention, it further comprises a step of deactivating for an object that is being far away after the step of activating the communicating process, in which the communicating module is switched to the sleeping mode when the object is recognized as being far way from the electrical doorbell after the electrical doorbell is triggered and a notification signal is sent via the communicating module.

According to an aspect of the present invention, after the step of activating the photographing process, if the object before doorbell has been sensed that it is away from the doorbell over a predetermined distance range, the first processor and the second processor returns to sleeping mode.

According to an aspect of the present invention, in the step of activating the photographing process, the photographing module and the second processing module are activated by the first processor.

According to an aspect of the present invention, after the step of activating the first processor, the second sensor is activated by the first processor.

With the characteristic features of the present invention as above, a low energy consuming processor and a plurality of sensors are employed for determining whether the smart doorbell should be configured in an operating mode or a sleeping mode by use of an image identification and a movement identification so as to achieve a goal of real time response to a bell call by consuming less energy.

### BRIEF DESCRIPTION OF THE DRAWINGS

The structure and the technical means adopted by the present invention for achieving the above and other objects can be best understood by referring to the following detailed description of the preferred embodiments and the accompanied drawings.

FIG. 1 is a schematic drawing illustrating a smart doorbell in one embodiment of the present invention;

FIG. 2 is a flowchart illustrating the energy-saving method for operating a smart doorbell in one embodiment of the present invention;

FIG. 3 is another flowchart illustrating the energy-saving method for operating a smart doorbell in one embodiment of the present invention; and

FIGS. 4A to 4D are schematic drawings illustrating the operation modes of the energy-saving method for operating a smart doorbell in one embodiment of the present invention;

### DETAILED DESCRIPTION OF THE PREFERRED EMBODIMENTS

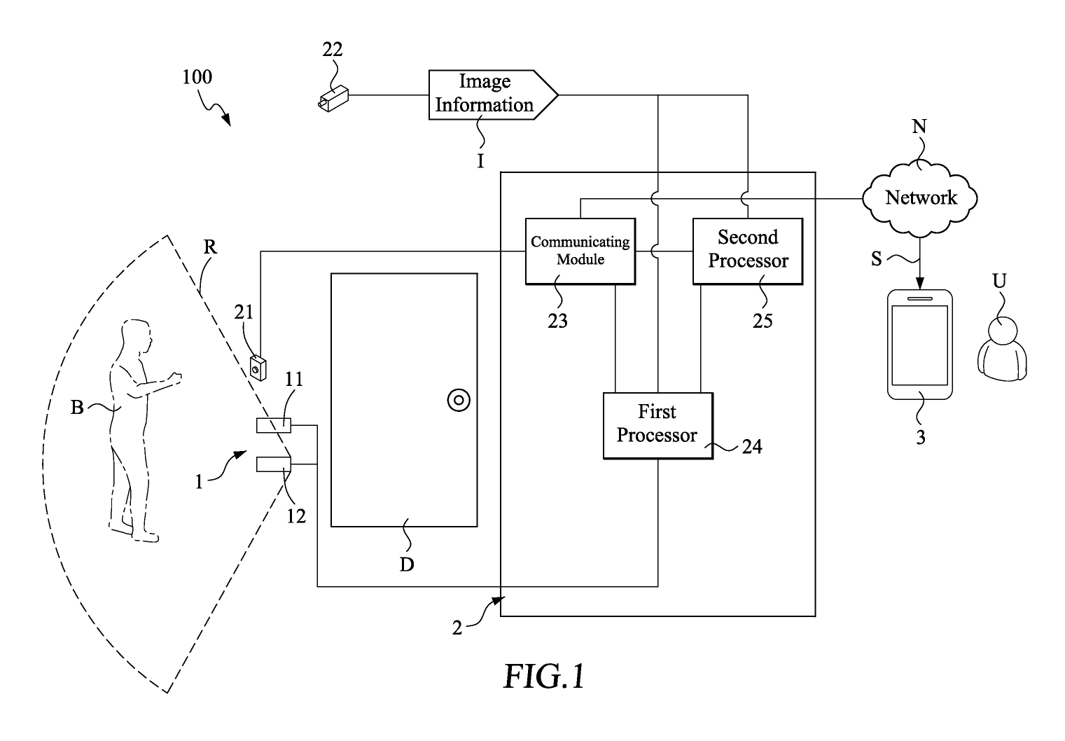

The energy-saving method of the present invention is provided by which a smart doorbell 100 is operated in an energy-saving manner, as shown in FIG. 1. The smart doorbell 100 comprises a sensing element 1 and an activating element 2. The sensing element 1 includes a first sensor 11 and a second sensor 12. The activating element 2 includes an electrical doorbell 21, a photographing module 22, a communicating module 23, a first processor 24, and a second processor 25. The activating element 2 is remained in a sleeping mode when it is not activated.

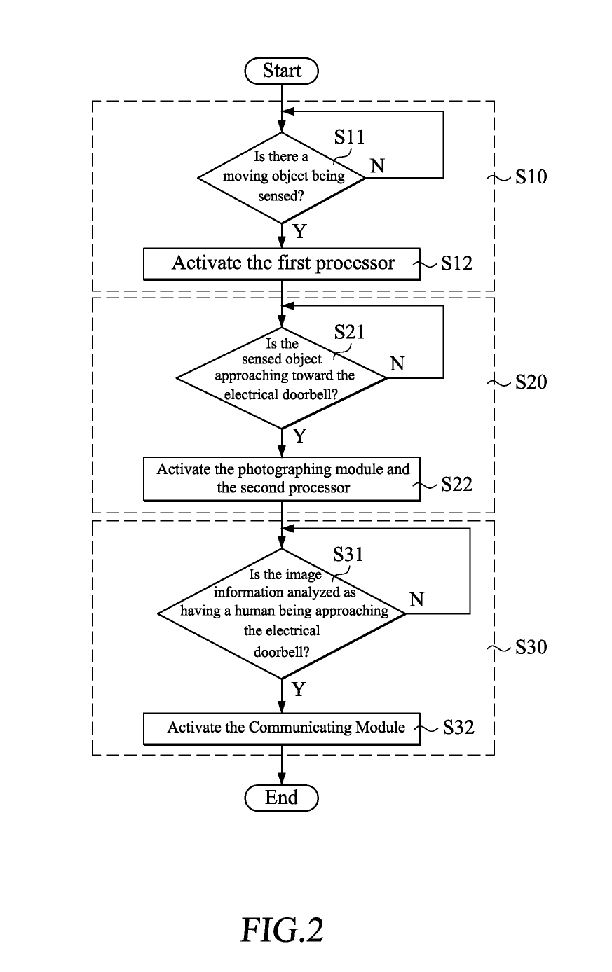

As referring to FIG. 2, it is a flowchart illustrating the energy-saving method in one embodiment of the present invention. The energy-saving method comprises steps of: a step of activating the first processor (Step S10), a step of activating the photographing process (Step S20), and a step of activating the communicating process (Step S30).

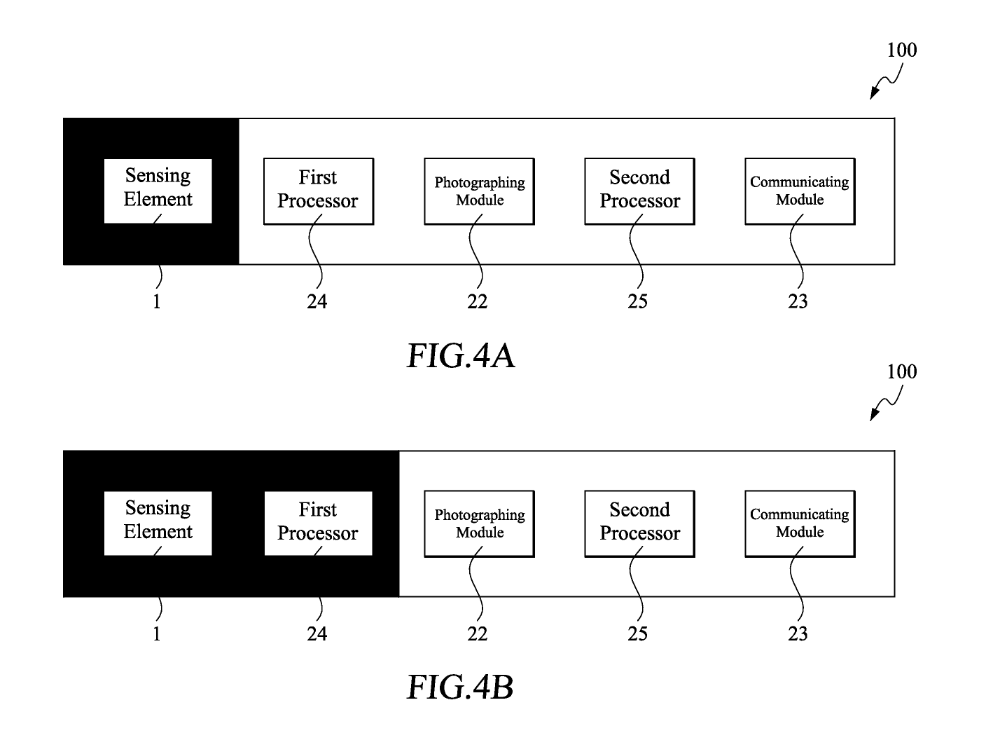

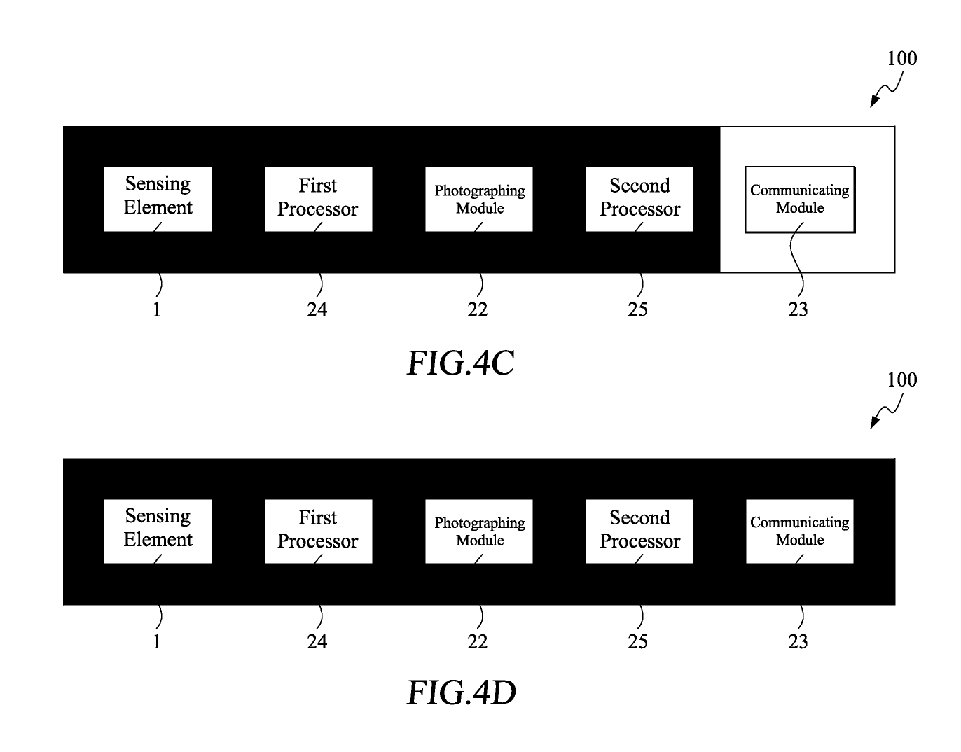

As also referring to FIGS. 4A to 4D, the energy-saving method of the present invention is described as follows:

Initially, the smart doorbell 100 is in a first phase operating mode where only the sensing element 1 is in an activated state, as shown in FIG. 4A. Firstly, the step of activating the first processor (Step S10) includes sensing whether an object B is moving or not (Step S11). And when the first sensor 11 senses that the object B is moving, the first processor 24 will be activated from sleeping mode (Step S12). Specifically, in this embodiment, the first sensor 11 is an infrared light sensor and the first processor 24 is a low energy consuming processor. For example, when a person, i,e, an object, is about to approach toward a door D (FIG. 1) from meters away, the first sensor 11 senses the movement of the person, and thus triggers and activates the first processor 24 from the sleeping mode. Then the smart doorbell 100 enters a second phase of the operating mode, as shown in FIG. 4B.

Next, the step of activating the photographing process (Step S20) includes sensing whether the object is approaching toward the electrical doorbell (Step S21). When the second sensor 12 senses that the object B is approaching toward the electrical doorbell 21, the photographing module 22 and the second processor 25 will be activated from sleeping mode (Step S22), and then the photographing module 22 captures an image of the object B to obtain an image information I for further analysis. Specifically, in this embodiment, the second sensor 12 is a thermal energy sensor and the second processor 25 is a main processor. For example, the second sensor 12 senses whether the object B is approaching closer to the electrical doorbell 21 or not. If the object B has been sensed that is approaching closer to the electrical doorbell 21, the photographing module 22 and the second processor 25 will be activated from the sleeping mode, and the smart doorbell 100 enters a third phase of the operating mode, as shown in FIG. 4C. The second processor 25 analyzes the image information I of the object B captured by the photographing module 22 by means of an image recognition. In this embodiment, after the step of activating the first processor (Step S10), the second sensor 12 is activated by the first processor 24.

And then, the step of activating the communicating process (Step S30) includes analyzing whether the image information I is an image of a human being approaching the electrical doorbell 21 or not (Step S31). When the image information I has been analyzed that it is an image of human being approaching toward the doorbell 21, the communicating module 23 will be activated from the sleeping mode (Step S32). For example, when an analysis result indicates that the image information I is indeed an image of a human being approaching the electrical doorbell 21, the communicating module 23 which comprises a network system, such as wireless network, will be activated. The smart doorbell 100 is now in a fully operating mode, as shown in FIG. 4D. Under this scheme, the wakeup time for the entire smart doorbell 100 is shortened.

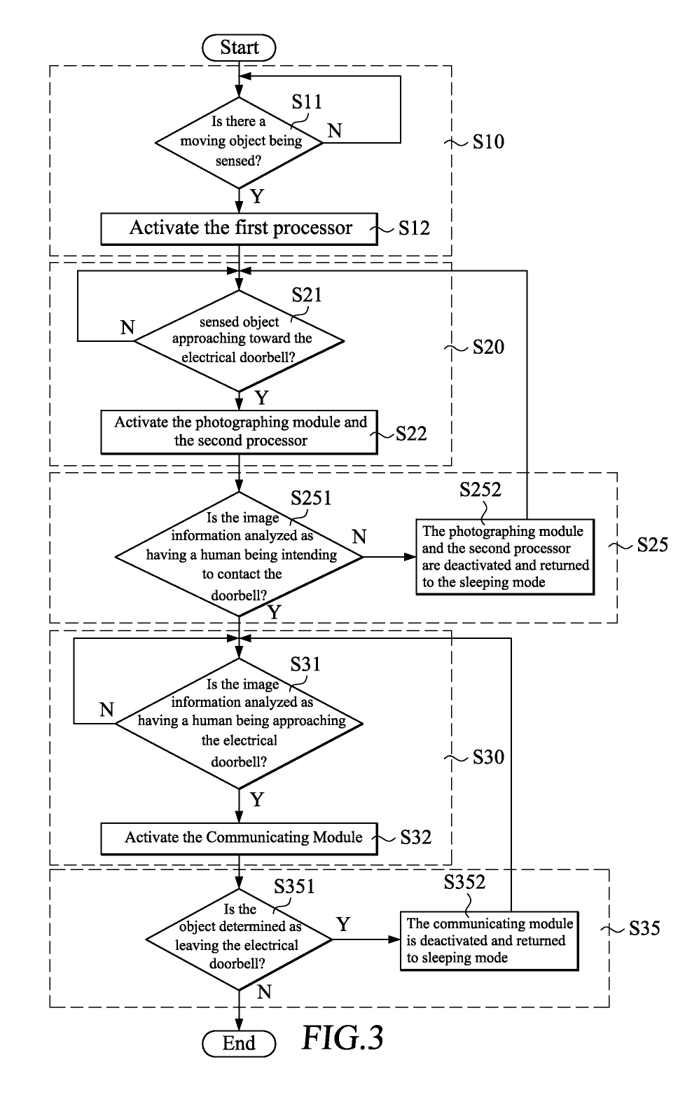

Further, as show in FIG. 3, after the step of activating the photographing process (Step S20), the method further comprises a step of deactivating the photographing module 22 and second processor 25 in a non-contact condition (Step S25). The deactivating step (Step S25) includes a step of analyzing the image information I, to determine whether it is a human being intending to contact the doorbell or not (Step S251). When the human image has been analyzed as not contacting the electrical doorbell 21, the photographing module 22 and the second processor 25 will be deactivated and returned to the sleeping mode (Step S252). The smart doorbell 100 is now enters to the second phase of operating mode (FIG. 4B) from the third phase of operating mode (FIG. 4C).

Alternatively, after the step of activating the photographing process (Step S20), when the object B has been sensed as being away from the doorbell 21 over a predetermined distance range R, the first processor 24, the second processor 25, and the photographing module 22 will be deactivated and returned to sleeping mode. In other words, the smart doorbell 100 is now returned to first phase of operating mode (FIG. 4A) from the third phase of operating mode (FIG. 4C).

Furthermore, after the step of activating the communicating process (Step S30), the method further comprises a step of deactivating the communicating module 23 when the target leaves the doorbell (Step S35), as shown in FIG. 3. In the step of activating the communicating process (Step S30), after the electrical doorbell 21 is triggered and a notification signal S is sent to a monitoring device 3 of a user U via the communicating module 23 over the network N, the doorbell determines that whether the object B is leaving the electrical doorbell 21 or not (Step S351). When the object B has been sensed as leaving the electrical doorbell 21, the communicating module will be deactivated and returned to sleeping mode (Step S352). The smart doorbell 100 is now operated as entering to the third phase of the operating mode (FIG. 4C) from the fully operating mode (FIG. 4D).

The above description should be considered as only the discussion of the preferred embodiments of the present invention. However, a person with an ordinary skill in the art may make various modifications to the present invention. Those modifications still fall within the spirit and scope defined by the appended claims.

What is claimed is:

1. An energy-saving method for operating a smart doorbell, by which the smart doorbell is operated in an energy-saving manner, the smart doorbell including a sensing element and an activating element, the sensing element comprising a first sensor and a second sensor, and the activating element comprising an electrical doorbell, a photographing module, a communicating module, a first processor, and a second processor, wherein the activating element is in a sleeping mode before being activated, the energy-saving method comprising:
a step of activating the first processor, in which the first processor is activated from the sleeping mode when the first sensor senses a movement of an object;
a step of activating a photographing process, in which the photographing module and the second processor are activated from the sleeping mode when the second sensor senses that the object is approaching toward the doorbell, so that the photographing module captures an image of the object and analyzes the captured image information of the object; and
a step of activating a communicating process, in which the communicating module is activated from the sleeping mode when the analyzed image information is analyzed as that a human being is approaching toward the electrical doorbell.

2. The energy-saving method of claim 1, wherein the first processor is a low energy consuming processor, and the second processor is a main processor.

3. The energy-saving method of claim 1, wherein the first sensor is an infrared light sensor.

4. The energy-saving method of claim 1, wherein the second sensor is a thermal energy sensor.

5. The energy-saving method of claim 1, further comprising a step of deactivating for a non-contact intention after the step of activating the photographing process, in which the second processor is switched to the sleeping mode when the analyzed image of the human being is recognized as not to contact the electrical doorbell.

6. The energy-saving method of claim 1, further comprising a step of deactivating for an object that is being far away after the step of activating the communicating process, in which the communicating module is switched to the sleeping mode when the object is recognized as being far way from the electrical doorbell after the electrical doorbell is triggered and a notification signal is sent via the communicating module.

7. The energy-saving method of claim 1, wherein after the step of activating the photographing module, if the object before doorbell has been sensed that it is away from the doorbell over a predetermined distance range, the first processor and the second processor returns to sleeping mode.

8. The energy-saving method of claim 1, wherein in the step of activating the photographing process, the photographing module and the second processing module are activated by the first processor.

9. The energy-saving method of claim 1, wherein after the step of activating the first processor, the second sensor is activated by the first processor.
